(19) United States
(12) Patent Application Publication
(10) Pub. No.: US 2012/0118076 A1
(43) Pub. Date: May 17, 2012

(54) Method of Detecting, Measuring, Correcting and Removal of Ice for a Pitot-Static Based Airspeed Detection Syeste for an Aircraft

(76) Inventor: George B. Foster, (US)

(21) Appl. No.: 13/295,514

(22) Filed: Nov. 14, 2011

Related U.S. Application Data
(63) Continuation-in-part of application No. 13/186,037, filed on Jul. 19, 2011.
(60) Provisional application No. 61/365,395, filed on Jul. 19, 2010.

(51) Int. Cl. G01F 1/46

(52) U.S. Cl. 73/861.65

(57) ABSTRACT

Test pressure bursts are utilized to eject a burst of air into the two channels of a pitot-static airspeed detection system and decay times for that air pressure are evaluated with respect to aircraft altitude. A higher-pressure burst of air may be employed to clear ice from a pitot-static channel.

### CROSS-REFERENCE TO RELATED APPLICATIONS

This application is a continuation-in-part of co-pending U.S. patent application Ser. No. 13/186,037, filed Jul. 19, 2011, and claims the benefit of the provisional application having Ser. No. 61/365,395, filed Jul. 19, 2010, the disclosures of which are expressly incorporated herein by reference.

### STATEMENT REGARDING FEDERALLY SPONSORED RESEARCH

Not applicable.

### BACKGROUND

In 2009, an A330-200 airliner designated as Air France Flight 447 (AF447) crashed into the Atlantic Ocean during its flight from Rio de Janeiro to Paris with the loss of all on board. It appeared that the aircraft encountered severe weather, including cumulus clouds and rain. Such weather can exhibit updrafts carrying super cooled liquid water at the center region of the cloud. Such super-cooled water will rapidly crystallize to form ice on airframe structures when crystallization is nucleated by contact with the structure of an aircraft. At the peripheral regions of thunderstorm clouds, updrafts are commonly encountered. The result of the combination of rapid icing and updraft or wind-shear phenomena can result in the imposition of airframe stresses exceeding design capability.

When the AF447 flight failed to establish contact with ground controllers or arrive in Paris, investigations and surface searches soon concluded that the aircraft had crashed into the Atlantic Ocean. The aircraft involved in the AF447 flight was an Airbus A330, which employs an automated “fly-by-wire” control system. Initial investigations showed that during the AF447 flight, the aircraft's automatic communications and reporting system (Acars) broadcast messages to Air France, with those messages indicating discrepancies in airspeed readouts among the several pitot-static speed sensors. Almost two years passed before data recorders from the flight were recovered. It has been opined that icing of the sensors resulted in a measured airspeed that was lower than the aircraft's actual airspeed, and that the ability of the pitot-static airspeed sensing system to accurately report airspeed was compromised. The ultimate result was inappropriate pilot or automated control system reactions, leading to an unrecovered stall of the aircraft. Unable to correctly discern their airspeed, the pilots either failed or were unable to correct the stall by increasing engine power or reducing the angle of attack of the aircraft. The black box data recording devices after recovery, confirmed invalid and inconsistent airspeed readouts. The final minute of the flight involved a vertical airspeed of more than −10,000 feet/minute, and an attitude of more than 35 degrees, nose up.

Prior to the AF447 crash, a number of other serious incidents have occurred involving failure of the pitot-static airspeed indicator system. Other pitot-static based aircraft failures include: Austral Lineas Aereas flight 2553; Birgenair flight 301; Northwest Orient Airline flight 6231; AeroPeru flight 603 (blocked static ports); and one X-31. A continuing risk for airframes losing airspeed indication—in addition to impact crashes—is that pilot responses to a perceived stall or low airspeed reading may include adding power to an already overtaxed airframe, leading to damage to or disintegration of the airframe.

Pitot tube icing is a known problem, and electrically powered heaters are available on most pitot-static installations. Unfortunately, heater based approaches to controlling over-icing do not appear to be sufficiently effective, especially in conditions of super-cooled ice nucleation. Severe icing conditions may be triggered so rapidly that heaters cannot counteract the icing before airspeed indication is lost. Thus, a system for evaluating the integrity of a pitot-static based airspeed detection system is of great importance. Moreover a reliable system for detecting and correcting icing conditions that interfere with airspeed indications is needed to avoid the repeat of conditions that can lead to loss of aircraft or life. A wide variety of icing detection systems have been proposed, but clearly the general problem has not been solved, especially for pitot-static airspeed indicators. One example of an icing detection system is disclosed in U.S. Pat. No. 5,301,905, issued Apr. 12, 1994 to Blaha.

The basic pitot tube system is a relatively simple structure based on Bernoulli's principle. The pitot tube system was invented by the French hydraulic engineer Henri Pitot (1695-1771) and later to be modified to its modern form by Henry Darcy. For conventional aircraft usage, pitot-static tubes, which are also referred to as “Prandtl” tubes are about 10 inches (25 cm) long with a ½ inch (1 cm) diameter. One or several small holes are present around the outside of the tube and the center channel is disposed along the axis. The outside holes are connected to one side of a pressure transducer while the center channel couples to the opposite side of such device. By aligning the axis of the tube with the airflow passing the aircraft, a variety of aircraft flight control data including airspeed may be derived.

In general, Bernoulli's equation is used to derive velocity. In this regard, Bernoulli's equation may be expressed as follows:

$$( {p}_{s} + \frac{{rV}^{2}}{2} ) = {p}_{t} .$$

### Solving for Velocity:

V²=2(pₜ−pₛ)/r.

Since the outside holes are perpendicular to the direction of airflow, these tubes are pressurized by the local random component of air velocity. The pressure in these tubes is the static pressure, pₛ discussed above. The center tube, however, is pointed in the direction of travel and is pressurized by both the random and ordered air velocity. The pressure in this tube is the total pressure, pₜ discussed in the equation. The pressure transducer of the pitot-static tube measures the difference in total and static pressure which is the dynamic pressure, q. The square root function of the above is taken to derive velocity, v, and, r, is density.

### BRIEF SUMMARY

The present invention is directed to a method and system for evaluating the integrity of a pitot-static based airspeed detection system, one aircraft at an altitude having at least one pitot-static system with a pitot pressure channel and a static air pressure channel. The method comprises the steps of providing a static pressure feed channel arrangement extending in pressure conveying relationship with a pitot navigation system;

Providing a static pressure feed valving assembly within the static pressure feed channel actuatable between on and closed conditions;

Providing a dynamic pressure feed channel arrangement extending in pressure conveying relationship with the pitot navigation system;

Providing a dynamic pressure feed valving assembly within the dynamic pressure feed channel actuatable between on and closed conditions;

Providing an active test pressure source at a predetermined pressure level above the current aircraft altitude flight pressure level;

Providing a compilation of pitot pressure channel no ice or no channel blocking based pressure decay time T1, of a predetermined burst of air from the active pressure test source for a plurality of altitudes at which the aircraft may fly;

Actuating the dynamic pressure feed valving assembly to a closed condition;

Applying a burst of air for predetermined interval to the pitot pressure channel and monitoring its decay interval to reach the current aircraft altitude flight level pressure;

Accessing decay time T1 from the compilation for the current aircraft altitude;

Determining the total decay time, T3 as a sum of no iced decay time, T1, plus any time extension, T2, thereof; and

Providing an airspeed fault signal in the presence of a time extension, T2.

The invention, accordingly, comprises the system and method possessing the construction, combination of elements, steps and arrangement of parts, which are exemplified in the following detailed disclosure.

For a fuller understanding of the nature and objects of the invention, reference should be had to the following detailed description taken in connection with the accompanying drawings.

### BRIEF DESCRIPTION OF THE DRAWINGS

FIG. 1 is a schematic representation of an airliner with a forward nose region laminar airflow about which are disposed 3 pitot-static tube systems;

FIG. 2 is a side view with portions shown in phantom of a pitot-static structure shown in FIG. 1;

FIG. 3 is a front view of the pitot-static structure shown in FIG. 2;

FIG. 4 is a block diagram of the system of the invention;

FIG. 5 is a pictorial representation of an in-cockpit read-out representing ice status and corrected airspeed; and

FIG. 6 is a chart showing the decay times for the absence and presence of ice in a pitot-static system.

### DETAILED DESCRIPTION

The invention is embodied in an improved pitot-static airspeed indicator system that maintains functionality in a variety of severe operating conditions. In the description to follow, the improved system is shown as implemented with the installation of multiple pitot-static based airspeed inputs at the forward region, i.e., nose, of an aircraft. As described, the aircraft nose is shown with three pitot-static based airspeed input structures, including a conventional pitot structure. One pitot channel will be described with a schematic depiction of a pitot tube in conjunction with the method and system of the invention. The condition of the improved pitot assembly is monitored with respect to channel blockage occasioned by ice or the like. A system for clearing the pitot tube system is provided, whether clearing occurs at ground level or various altitudes. In conjunction with this system description, a visually perceptible readout to an aircraft pilot is portrayed for three airspeed channels of performance and, finally, a chart is presented showing decay times for evaluating the presence and extent of blockage of ice or the like within a pitot channel.

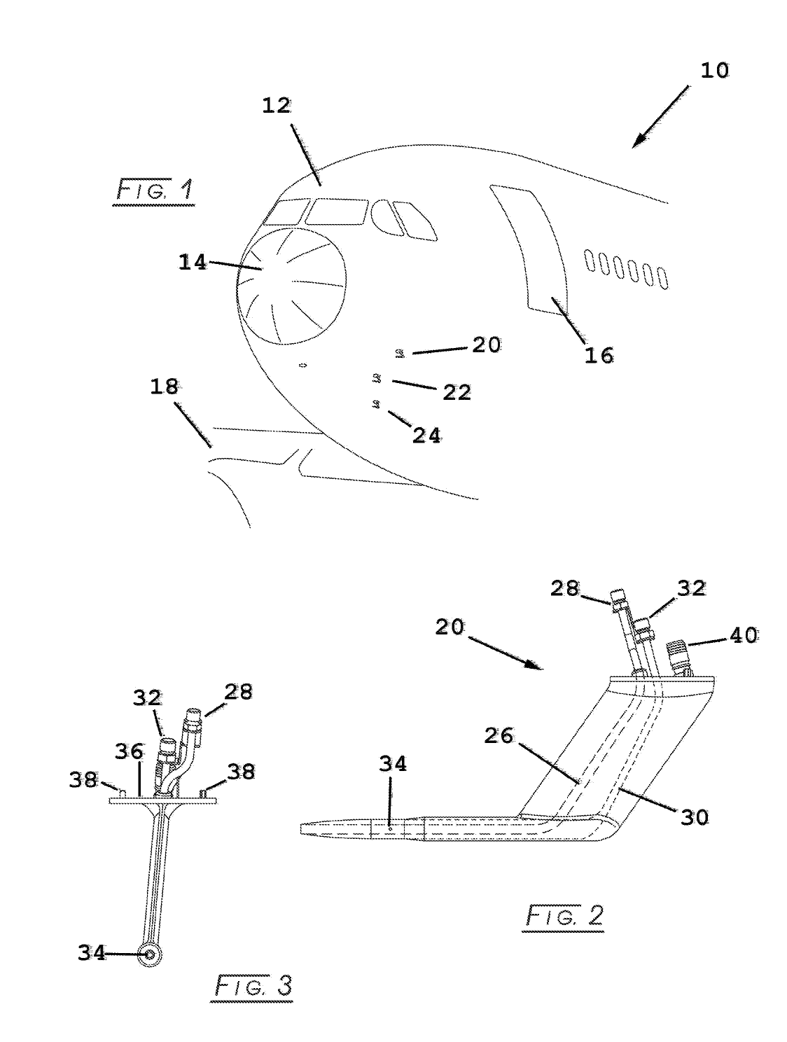

Referring now to FIG. 1, the forward portion of an aircraft is schematically portrayed in general at 10. In this regard, aircraft 10 is seen to incorporate a forward cabin portion with windshields as at 12 and a forward dome 14. A forward access door is shown at 16 and a forwardly directed motor cowling is represented generally at 18. The inputs of three discrete pitot-static channels are shown at 20-24. A side view of one such pitot-static tube, as used with the presently disclosed system is represented in FIG. 2, again using the numeral 20. Looking to that figure, a dynamic pressure feed channel is shown at 26 that extends to a fitting 28 and a corresponding static channel is shown at 30 extending to a fitting 32. A lateral opening is provided in the static channel and is shown at 34. A dynamic pressure feed channel opening is shown again in FIG. 3 with the same numeration as the static channel. Additionally, fittings 28 and 32 appear in FIG. 3 extending upwardly from a support platform 36, with locator pins for mounting the pitot-static tube on the aircraft, as at 38, extending upwardly as well.

Returning to FIG. 2, an electrical fitting is shown at 40 which functions to apply current to a heating element or Joulian device intended to melt deposited ice (not shown), or to prevent ice accumulation during icing conditions.

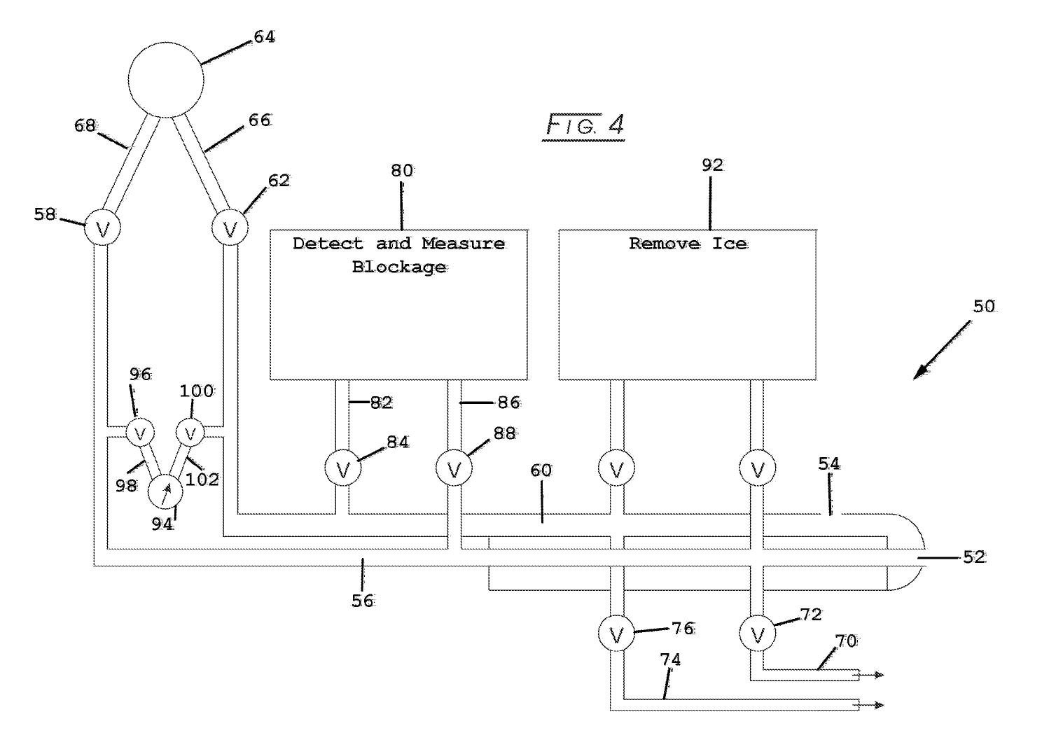

Turning to FIG. 4, a pitot-static tube is represented schematically in general at 50. Tube 50 is shown incorporating a dynamic pressure inlet 52 and a static pressure inlet 54. Dynamic pressure inlet 52 is incorporated with a dynamic pressure feed channel 56 that extends, in turn, to a dynamic test feed valving function 58. Correspondingly, static pressure inlet 54 is operationally associated with a static pressure feed channel 60. Channel 60, in turn, extends to a static test feed valving function 62. Note that valving functions 58 and 62 are operationally associated with an active test pressure source 64 carrying a pre-determined pressure level above any current aircraft altitude flight level pressure and, for example, may provide a test pressure of about 20 psi. Static test feed valving function 62 is associated operationally with source 64 via channel 66 while dynamic test feed valving function 58 is associated with that same source via channel 68.

Dynamic pressure is asserted along dynamic feed channel 70 to the dynamic pressure input to the aircraft navigational system. That input is regulated by dynamic pressure valving function 72. Correspondingly, the static feed pressure extends via static feed channel 74 to the navigation system and is controlled by a static pressure valving function 76.

The present system provides for a pitot-static tube blockage detection and measurement function. A detect and measure blockage control function is shown at block 80. Static pressure input to control function 80 is shown at channel 82 incorporating a valving function 84. Correspondingly, dynamic pressure is asserted via conduit 86 containing valve 88 to function 80. Actuation of valves 84 and 88 occurs during the detection and measurement of blockage control function 80.

The described physical components operate to detect the presence of pitot-static tube icing or other blockages, and then to correct those blockages with other system components. The detection system relies on comparison of measured readings of decay time with expected calibration values. To proceed with the monitoring and measuring of ice conditions, the system at hand utilizes a collection of calibrating no ice decay times over a sequence of flight altitude levels, for example, 420 such levels extending to an altitude of about 45,000 feet. This collection may be compiled in a lookup table utilizing conventional computational technology. While a collection of 400-500 calibrating no ice or no blockage decay times may be sufficient for most applications, if necessary, the number of calibrating values provided in the look-up table may be increased, so that a wide variety of flight conditions are anticipated, including altitudes from sea level to an altitude exceeding the expected flight ceiling. In addition, the described calibrating look-up table can incorporate calibrating values that are corrected to account for changes in barometric pressure variations, temperature effects or other environmental factors, if needed.

The convention used for pitot-static systems today is to employ a “majority rules” operation to the three or more pitot-static detection systems employed on an aircraft by indicating to the aircraft display and control system the airspeed detected and measured by two of the three detection systems. If the majority of the pitot-static indicator systems have large but similar errors, however, the indicated airspeed (i.e., the airspeed measured by the device, without error correction) will be incorrect. Large, but similar, errors in airspeed indication can lead to the aircraft control system reacting inappropriately, and placing the aircraft in danger. The system shown in FIG. 4 acts to determine airspeed, and then to detect the presence of an erroneous airspeed indication. The present system first calculates the indicated airspeed by measuring the dynamic and static pressures via the dynamic feed channel 70 and static feed channel 74, respectively. Then, using the detect and measure blockage control function, any error due to iced conditions is quantified, followed by providing a corrected airspeed to the cockpit displays or control systems.

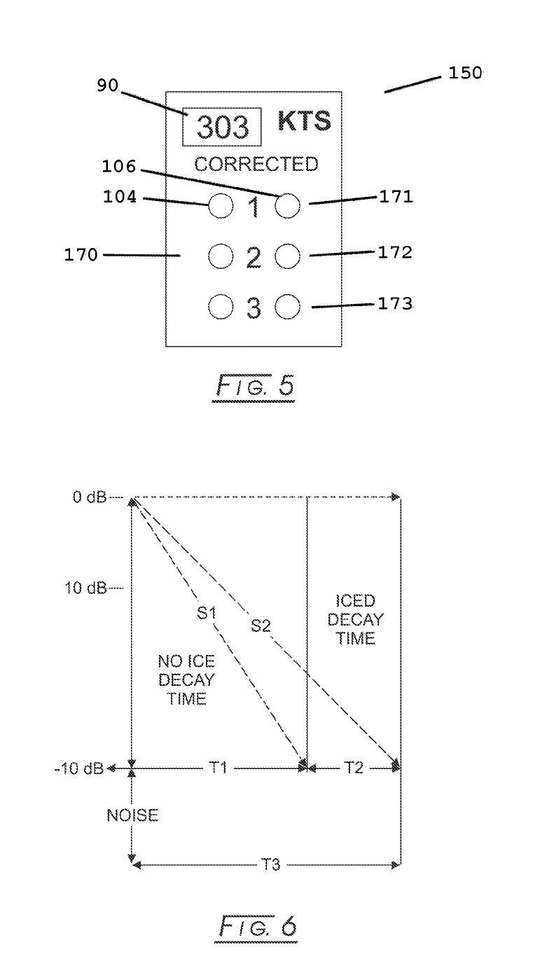

As shown in FIG. 4, detect and measure function 80 monitors pitot-static tube blockage by initially closing valving functions 72 and 76. In this regard, a short burst of air under pressure is developed from pressure source 64, the pressurized air delivered initially via valve 58 and channel 68. That burst of air pressure, above the altitude base pressure, is measured as an iced decay time. The no-ice (no blockage) decay time for various altitudes are provided in the lookup table of calibrating no-ice decay times. Such a decay time for a no-iced condition is represented in FIG. 6 as curve S1.

As shown in FIG. 6, the decay time for the indicated signal to decay from 0 dB to −10 dB is shown as T1. On the other hand, should there be ice or some blockage in the pitot system, when the air pressure burst is delivered from pressure source 64, the decay time is extended and the decay time is indicated as an iced decay time. Thus, in FIG. 6, the decay time will expand as represented at curve S2, adding a time T2 to the no-iced decay time T1. The total of decay times T1 and T2 is represented as T3. From these two times a ratio R_{c} can be derived as T3/T1. The ratio R_{c} gives the detect and measure system an indication as to: 1) the presence of ice at the pitot system; and 2) the extent and quantification of such ice. Thus, the determination of the ratio R_{c} can be utilized to provide for an error indication in airspeed readings, a corrected airspeed based on the measured error, or to activate a pitot-static tube ice removal system.

Returning to FIG. 4, the same test can be carried out using source 64, through valving function 62, and channel 66 extending to the static pressure feed channel 60. The ratio R_{c} also can be used to evolve a corrected airspeed by applying the ratio to the indicated air speed and issuing a corrected airspeed. The corrected airspeed is a product of the indicated airspeed multiplied by the ratio R_{c}. The corrected airspeed may be published to the pilot or control systems (see discussion of FIG. 5 at 160, below). This is labeled “corrected” airspeed and is expressed in knots. The corrected airspeed and R_{c} ratio can be utilized by automated control systems to avoid erroneous flight control corrections, or used to activate alarms alerting the flight crew to potential incorrect indications. Typically, pitot-static systems may contain a resistive heating component. The resistive heating component can be automatically activated at any time that R_{c} is greater than 1, or any other desired minimum error threshold. The R_{c} ratio determination can be further utilized to provide an indication if icing conditions have been relieved.

The remove ice function shown at block 92 of FIG. 4 is configured to clear ice from both the dynamic pressure feed channel as well as the static pressure feed channel. The clearance of ice or other blockages is carried out utilizing a pneumatic pressure source represented at symbol 94, providing a higher pressure output than is used for the blockage detection system. The pneumatic pressure used for clearance purposes is, for example, 90 psi. To activate blockage clearance, looking initially to the dynamic pressure feed channel 56, valving function 96 is opened to create an ice-clearing burst of air from source 94 as represented at channel 98 and its connection with dynamic pressure feed channel 56. During blockage clearance, valve 58 will typically remain closed. Similarly, the static pressure feed channel may be cleared of ice or the like by actuating valve 100, with valve 62 closed, and providing the high burst of pneumatic pressure to the static pressure feed channel 60. Following this ice-clearing procedure, the static and dynamic channels are again tested via the detect and measure control function 80 to determine whether the blockage of ice has been successfully removed. For instance, if the R_{c} ratio does not return to an acceptable level, the system controls indicate that icing conditions have not been relieved. In the event such blockage is not removed, then the blockage clearance procedure is carried out again.

Using this system and method, the error present in the indicated airspeed for each of the pitot-static systems employed in an aircraft flight system can be continually monitored and used to indicated a corrected airspeed. Thus, the pitot-static system with the lowest error can be displayed to the pilots, while the remaining channels are monitored and cycled through de-icing operations. Alternatively, the monitoring of the presence of airspeed errors can be determined with a particularly chosen cycle time, and the blockage clearance procedure can be cycled at a predetermined rate. Pitot-static tubes providing aberrant airspeed readings can be removed from the system displaying “majority rule” airspeed, thereby enhancing the reliability of such a system.

Returning to FIG. 5, perceptible indicators of airspeed indicator status can be provided to the pilot. FIG. 5 shows a panel indicator generally at 150. Panel indicator 150 provides the corrected airspeed reading at 90, and could also be configured to show an indicated airspeed reading. The corrected airspeed reading can be calculated or displayed in a variety of ways, including, for instance, using an average of corrected airspeeds taken by “majority rules” after eliminating readings taken from pitot systems with errors that exceed a predefined threshold, or by displaying the corrected airspeed taken from the pitot system with the lowest measured error.

Pitot-static tube status indicators for three pitot-static tubes are shown at 170, with tube 1, 2, and 3 indicating at 171, 172, and 173, respectively. The left indicator light, as at 104, show test status indications. The test status indicators can be configured to show a successful test with a steady green light for the online channel, as at 104 for the first channel, or a blinking yellow visual output at 104 for a successful test if the indicated pitot-static system is an offline channel. The indicators in the right column, as at 106, are configured to indicate icing conditions. Indicator 106 can show red for the presence of ice above a threshold error beyond the normal operating limit, for example 10%. The indicator 106 could alternatively display yellow for the presence of ice introducing, for example, an error between 1% and 10%.

Since certain changes may be made in the above-described system and method without departing from the scope of the invention herein, it is intended that all matter contained in the description thereof or shown in the accompanying drawings shall be interpreted as illustrative and not in a limiting sense.

I claim:

1. A method for detecting and correcting the effects of ice on a pitot-static based airspeed detection system for an aircraft at an altitude having at least one pitot-static system with a dynamic air pressure channel and a static air pressure channel, comprising the steps:
providing a static pressure feed channel arrangement extending in pressure conveying relationship with a pitot navigation system;
providing a static pressure feed valving assembly within the static pressure feed channel actuatable between on and closed conditions;
providing a dynamic pressure feed channel arrangement extending in pressure conveying relationship with the pitot navigation system:
providing a dynamic pressure feed valving assembly within the dynamic pressure feed channel actuatable between on and closed conditions;
providing an active test pressure source at a predetermined pressure level above the current aircraft altitude flight level pressure;
providing a compilation of pitot pressure channel, no ice or no channel blocking based pressure decay times, T1, of a predetermined burst of air from the active pressure test source for a plurality of environments through which the aircraft may fly;
actuating the dynamic pressure feed valving assembly to a closed condition;
actuating the static pressure feed valving assembly to an on condition;
applying a calibrated pressure burst of air to measure a predetermined interval to the static air pressure channel and monitoring its decay interval to reach or approach the current aircraft altitude flight level pressure;
accessing decay time T1, from the compilation for the current aircraft altitude;
determining the total decay time, T3, as the sum of no iced decay time, T1, plus any time extension, T2, thereof; and
providing an airspeed fault signal in the presence of a time extension, T2.

2. The method of claim 1 further comprising the step:
determining the ratio R_{c} as T3/T1 and providing a corrected airspeed by multiplying the indicated airspeed of the aircraft by R_{c} when R_{c} is greater than one.

3. The method of claim 1 further comprising the step:
applying heat automatically to the pitot pressure channel to maintain it above freezing temperature when the ratio R_{c} is greater than one.

4. The method of claim 2 further comprising the step:
providing a source of clear vent air under a pressure effective when actuated to blow ice from the pitot pressure channel.

5. The method of claim 4 further comprising the step:
manually actuating the source of clear vent air to blow ice from the pitot pressure channel when an operator chooses to clear the pitot-static based airspeed detection system.

6. The method of claim 4 further comprising the step:
automatically actuating the source of clear vent air to blow ice from the pitot pressure channel when R_{c} becomes greater than a predefined threshold being greater than one.

7. The method of claim 1 where the compilation of pitot pressure channel, no ice or no channel blocking based pressure decay times plurality of environments includes environmental corrections for one or more of altitude, barometric pressure, temperature and humidity.

8. The method of claim 7 where the environmental correction is for altitude.

9. The method of claim 4 where the method for detecting and correcting the effects of ice on a pitot-static based airspeed detection system for an aircraft at an altitude having at least one pitot-static system with a dynamic air pressure channel and a static air pressure channel is cycled at predefined intervals to verify removal of ice by confirming that ratio R_{c} has returned to a predetermined value.

10. A method for detecting and correcting the effects of ice on a pitot-static based airspeed detection system for an aircraft at an altitude having at least one pitot-static system with a dynamic air pressure channel and a static air pressure channel, comprising the steps:
providing a static pressure feed channel arrangement extending in pressure conveying relationship with a pitot navigation system;
providing a static pressure feed valving assembly within the static pressure feed channel actuatable between on and closed conditions;
providing a dynamic pressure feed channel arrangement extending in pressure conveying relationship with the pitot navigation system:
providing a dynamic pressure feed valving assembly within the dynamic pressure feed channel actuatable between on and closed conditions;
providing an active test pressure source at a predetermined pressure level above the current aircraft altitude flight level pressure;
providing a compilation of pitot pressure channel, no ice or no channel blocking based pressure decay times, T1, of a predetermined burst of air from the active pressure test source for a plurality of altitudes at which the aircraft may fly;
actuating the static pressure feed valving assembly to a closed condition;
actuating the dynamic pressure feed valving assembly to an on condition;
testing the pitot system for the presence of ice by:
applying a calibrated pressure burst of air to the dynamic air pressure channel; and
measuring a total decay time, T3, the time interval that the calibrated pressure burst of air take to reach or approach the current aircraft altitude flight level pressure;
accessing no ice decay time T1 from the compilation for the current aircraft altitude;
determining the total decay time, T3, as the sum of no iced decay time, T1, plus any time extension, T2, thereof;
providing an airspeed fault signal in the presence of a time extension, T2; and
calculating the ratio R_{c} as T3/T1.

11. The method of claim 8 further comprising the step:
providing a source of clear vent air under a pressure effective when actuated to blow ice from the pitot pressure channel.

12. The method of claim 11 further comprising the step:
applying heat automatically to the pitot pressure channel to maintain it above freezing temperature when the ratio R_{c} is greater than one.

13. The method of claim 12 further comprising the step(s):
providing a source of clear vent air under a pressure effective when actuated to blow ice from the pitot pressure channel.

14. The method of claim 13 further comprising the step:
manually actuating the source of clear vent air to blow ice from the pitot pressure channel when an operator chooses to clear the pitot-static based airspeed detection system.

15. The method of claim 13 further comprising the step:
automatically actuating the source of clear vent air to blow ice from the pitot pressure channel when R_{c} becomes greater than a predefined threshold being greater than one.

16. A system for detecting and correcting the effects of ice on a pitot-static based airspeed detection system for an aircraft at an altitude having at least one pitot-static system with a dynamic air pressure channel and a static air pressure channel, comprising:
a pitot-static airspeed detection component with a static pressure feed channel arrangement extending in pressure conveying relationship with a pitot navigation system;
a static pressure feed valving assembly within the static pressure feed channel, said valving actuatable between on and closed conditions, and actuated to an on condition;
a dynamic pressure feed channel arrangement extending in pressure conveying relationship with the pitot navigation system:
a dynamic pressure feed valving assembly within the dynamic pressure feed channel, said valving actuatable between on and closed conditions, and actuated to a closed condition;
an active test pressure source at a predetermined pressure level above the current aircraft altitude flight level pressure;
a compilation of pitot pressure channel, no ice or no channel blocking based pressure decay times, T1, of a predetermined burst of air from the active pressure test source for a plurality of environments through which the aircraft may fly;
applying a calibrated pressure burst of air to measure a predetermined interval to the static air pressure channel and monitoring its decay interval to reach or approach the current aircraft altitude flight level pressure;
accessing decay time T1, from the compilation for the current aircraft altitude;
determining the total decay time, T3, as the sum of no iced decay time, T1, plus any time extension, T2, thereof; and
indicating on a fault indicator an airspeed fault signal in the presence of a time extension, T2.

17. The system of claim 16 further comprising
determining the ratio R_{c} as T3/T1 and correcting the indicated airspeed of the aircraft by multiplying the indicated airspeed by R_{c} when R_{c} is greater than one and displaying the corrected airspeed on an airspeed display.

18. The system of claim 16 further comprising a sequential querying of a plurality of pitot-static airspeed detection components for the presence of blockage conditions.

19. The system of claim 18 further comprising a display for providing the status of blockage conditions for the plurality of pitot-static airspeed detection components.

20. The system of claim 19 further comprising a display of pitot-static airspeed detection component status for one or more of off-line status, on-line status, no fault status, warning status, and fault status.
